(19) United States
(12) Patent Application Publication
(10) Pub. No.: US 2013/0043119 A1
(43) Pub. Date: Feb. 21, 2013

(54) ELECTRONEGATIVE-ION-AIDED METHOD AND APPARATUS FOR SYNTHESIS OF ETHANOL AND ORGANIC COMPOUNDS

(71) Applicants: Yashen Xia, Newton, MA (US); Feng Chen, Belmont, MA (US)

(72) Inventors: Yashen Xia, Newton, MA (US); Feng Chen, Belmont, MA (US)

(21) Appl. No.: 13/588,941

(22) Filed: Aug. 17, 2012

Related U.S. Application Data
(60) Provisional application No. 61/575,264, filed on Aug. 19, 2011.

(30) Foreign Application Priority Data
Sep. 28, 2011 (CN) 201110268283.4

(51) Int. Cl. B01J 19/08

(52) U.S. Cl. 204/165; 422/186.04; 422/186.03

(57) ABSTRACT

Provided are electronegative-ion-aided methods and apparatus to achieve reduction of carbon dioxide gas into useful products. In one embodiment, using different methods of discharge, the electronegative gases forms non-equilibrium electronegative ions, so that carbon dioxide reduction occurs for the production of organic compounds. When carbon dioxide is introduced into the container containing at least one electronegative gas, such as water, ammonia, bromine or iodine vapor, it reacts to form organic compounds, such as ethanol, methanol, and oxalic acid in the case of water, urea in the case of ammonia, and tetraiodomethane in the case of iodine.

### CROSS-REFERENCE TO RELATED APPLICATIONS

This application claims the benefit of U.S. Provisional Application No. 61/575,264, filed Aug. 19, 2011, and Chinese Patent Application No. 201110268283.4 filed on Sep. 28, 2011, the contents of each of which are hereby incorporated by reference in their entirety.

### FIELD OF THE INVENTION

Methods and apparatus for synthesis of ethanol or other organic compounds are described. The methods of the present invention utilize a plasma source to provide energy to convert CO₂ to organic compounds such as ethanol. In one embodiment, the electron discharge from a negative corona is used to form electronegative gas ions, such as water vapor anions and carbon dioxide anions or reactive radicals from the starting gases such as OH⁻ under high energy conditions. The electronegative gas ions react with electrically neutral gas molecules to form ethanol or other organic compounds. The apparatus of the present invention includes a reactor vessel having at least one electrode and a high voltage source to produce a negative corona at the tip of the electrode. Electronegative gas ions are formed within the vessel in the region of the negative corona, and react with non-polar (i.e. electrically neutral) or gas molecules without attached electrons to form ethanol or other organic compounds.

### BACKGROUND OF THE INVENTION

One of the most difficult problems to address in the area of energy generation and storage is the efficient capture or utilization of carbon dioxide (CO₂). In particular, feasible technologies for the use or reduction of CO₂ at the production source, such as for example in flue gas, has been the subject of a great deal of research. Flue gases are typically at approximately atmospheric pressure and moderate temperatures. Utilization and reduction of CO₂ from flue gas and other large production sources is crucial for large-scale reduction of CO ₂ emissions. About two-thirds of greenhouse gas carbon dioxide is formed from combustion of fossil fuels and organic compounds. [1-3].

Currently, there are many efforts being undertaken to utilize carbon dioxide as a cheap resource material, using chemical methods to convert CO₂ into bulk chemicals, thereby turning a waste material into a valuable resource. However, carbon dioxide is an extremely stable gas at room temperature and atmospheric pressure. Accordingly, prior methods to convert CO₂ typically required elevated temperature and pressure, which increases the expense of treatment and can create safety hazards. There are also processes being developed involving plasma decomposition of carbon dioxide and restructuring to form useful compounds. [4˜6].

Electronegative gases have attracted attention mainly in applications related to surface processing, atmospheric science, and in environmental studies. There are many situations in contemporary plasma physics in which the role of negative ions is significant. The fundamental properties of negative gas ions have been extensively studied. [7˜9].

The present invention utilizes a plasma source to provide energized electrons to create electronegative gas ions to convert CO₂ to useful chemicals such ethanol. In one embodiment, a negative corona is formed around an electrode to produce the required electrons. A negative corona reaction is a process by which a current develops from an electrode with a high negative potential in at least one electronegative gas, for example, water vapor, by attaching an electron to gas molecules to produce electronegative gas ions around the electrode. The electrode may be in the shape of a needle or wire having a sharp point at the tip. When the potential gradient is large enough at the tip of the electrode to emit electrons to the gas, an excess electron will attach to the gas molecule to form an electronegative gas ion. With an electrode having a sharp point, the gas adjacent to that sharp point will be at a much higher gradient than elsewhere around the electrode. The electronegative gas ions generated eventually pass the charge to nearby areas of lower potential or recombine to form gas molecules.

The work needed to remove electrons from the corona electrode surface is approximately 4 to 5 eV for the metals most likely to be used as electrodes in the corona discharge device. The electrode may be comprised of nickel, copper, silver, iron, steel, tungsten, carbon or platinum. The invention is not limited to any particular type of electrode material, and any material capable of forming a negative corona to produce electrons having an energy of about 4-5 eV may be used. The discharged electrons may attach to low-speed electronegative gas molecules, which typically have relatively low kinetic energy (˜3/2 kT or 0.038 eV at 25° C.). The energy in the attached electrons results in formation of electronegative gas ions with higher kinetic energy. Additionally, due to excess electrical charge on the electronegative gas ions, the potential energy of the gas ions will be higher. The total internal energy of the electronegative gas ions will be higher than that of the original molecules, leading to highly energetic collisions between H₂O⁻ ions and CO₂. This provides the energy required to cause reactions between the H₂O- ions and CO₂ to form organic molecules such as ethanol.

While the invention is not limited to any particular mechanism, the inventors believe that the gas-phase reaction system utilizes an electronegative gas to generate negative gas ions by electron attachment from the negative corona. After excess electrons are attached on the gas molecules to form negatively charged radicals, energized anions and radicals are formed having energy of 4˜5 eV from the attached electrons from the corona discharge. These high energy negatively charged gas ions react with low-energy neutral gas molecules, such as CO₂, to form organic compounds such as ethanol to reach minimization of their energy.

If gases were used that did not form electronegative ions, fast electrons could only collide with heavy molecules to transfer the energy of the electrons (e.g., 4-5 eV) to gas molecules.

This would likely be much less than the ionization energy of non-polar molecules (e.g., 12.6 eV for CH₄) for forming positive ions and electrons, and would lack sufficient energy to activate the reaction with CO₂ at ambient temperature and pressure. Therefore, in the absence of electronegative gas ions, no anions could be formed and the electron energy is not efficiently transferred, reducing the chance of activating the reactants for completion of the desired reactions at ambient temperature and pressure.

Accordingly, one advantage of using electronegative gas ions is that the added energy in the gas anions is provided by negative corona electrons at relatively low temperature and pressure. This avoids the expense and difficulty of high-pressure and high-temperature methods previously used. Other advantages of the methods and apparatus of the present invention will be apparent to those skilled in the art based upon the description provided below.

### SUMMARY OF THE INVENTION

The present invention is generally directed, in one aspect, to methods for synthesis of ethanol or other organic compounds from CO₂ gas. One or more electronegative gases, such as water vapor, ammonia, bromine, iodine and carbon dioxide, are exposed to a source of electrons to form negatively charged gas ions. The source of electrons may be a typical plasma source that produces both positive and negative ions. In one embodiment, a negative corona source is used to produce the electronegative gas ions. In this embodiment, the one or more electronegative gases are exposed to a negative corona discharge and an electron is attached to the gas molecule to form negatively charged gas ions. The negatively charged gas ions are at an elevated energy state due to the energy of the attached electron. Typically, the negatively charged gas ions are energized by 4-5 eV by the attached electron. The high energy negative gas ions react with CO₂ to form organic compounds, such as ethanol, methanol, urea, oxalic acid and tetraiodomethane. The resultant organic compound can be used as a fuel or as an industrial feedstock for other chemicals.

In another aspect, a reactor vessel is provided for use in performing the methods described herein. The reactor vessel comprises an outer shell having a plurality of electrodes attached to the sides of the vessel. A high voltage source provides a negative charge to the electrodes. Each of the electrodes produces a negative corona that provides excess electrons that may be attached to an electronegative gas. Feed inlets are provided to feed CO₂ and an electronegative gas into the vessel, and an outlet for product gas is provided. Optionally, the vessel may contain one or more magnets to attract the electronegative gas ions and create a zone of highly concentrated electronegative gas ions.

The methods and apparatus utilize electronegative gas ions and CO₂ to induce reactions that result in synthesis of organic compounds from the CO₂. By reacting electronegative gas ions, such as water vapor, iodine, bromine or ammonia with CO₂, compounds such as ethanol, methanol, oxalic acid, tetraiodomethane, urea or other compounds can be synthesized at atmospheric pressure without any catalyst.

Other objects and advantages of the present invention will become apparent in view of the following detailed description of embodiments of the invention.

### BRIEF DESCRIPTION OF THE DRAWINGS

FIG. 1 is a schematic drawing of one embodiment of a reactor vessel for use in producing electronegative gas ions and synthesizing organic compounds from CO₂.

FIG. 2 is a flow chart illustrating one embodiment of facility for production of ethanol from CO₂ and H₂O.

### DETAILED DESCRIPTION OF THE INVENTION

As used in this description and in the claims, the term “electronegative gas” refers to a gas whose atoms or molecules have the capability of forming negative ions by attachment of excess electrons. All other technical and scientific terms used herein have the same meaning as commonly understood by a person of ordinary skill in the art.

In one embodiment of the methods of the present invention, a reactor vessel having at least one electrode capable of forming a plasma or a negatively charged corona is provided. The plasma or negative corona must be capable of providing electrons at a sufficiently high energy to convert CO₂ to the desired organic products. One embodiment of the invention using electrodes that provide a negative corona is described below. It should be understood that that the invention is not limited in this regard, and electrodes that generate a conventional plasma discharge producing electrons at a sufficiently high energy state could be used in the invention.

The reactor vessel is supplied with an electronegative gas and CO₂ through one or more feed lines. In the synthesis of organic compounds such as ethanol, the electronegative gas may be water vapor. Other organic compounds may be formed by feeding the reactor vessel with iodine, bromine or ammonia and CO₂. The process may be performed in either batch or continuous mode, although continuous mode is desirable for synthesis of larger quantities of the product.

A plurality of electrodes may be provided in the reactor vessel to create a field of negatively charged coronas around the electrodes. In some embodiments, the electrodes are wires or other needle-like elements to provide a sharp point at the tip of the electrode. The sharp tip provides a locus for a very highly negative-charged region in the immediate vicinity of the tip. The electrode may be comprised of nickel, copper, silver, iron, steel, tungsten, carbon or platinum. A nickel coated electrode may also be used. The invention is not limited to any particular type of electrode material, and any material capable of forming a negative corona to produce electrons having an energy of about 4-5 eV may be used.

The electrode in the vessel is energized using a high voltage source and a negatively charged corona is formed at the tip of the electrode. Electrons having an energy of 4-5 eV are generated in the corona at the electrode tip. These electrons attach to the electronegative gas molecules in the vicinity of the electrode, such as water vapor, to generate a high energy gas ion. The high energy gas ion will collide with other gas molecules in the vessel and react to form various synthesis products as described below.

The reactor vessel is typically operated at atmospheric pressure or slightly above atmospheric pressure. The temperature in the reactor vessel may be maintained at any desired temperature suitable for the electronegative gas used and for recovery of the product. Typically, the temperature of the vessel will be between ambient temperature and about 100° C. For example, when water vapor is used as the electronegative gas, the temperature in the reactor vessel may be raised to as high as 100° C. to prevent condensation of the water vapor on the inner walls or other structures within the reactor vessel. Alternatively, the temperature within the vessel may be maintained at less than 100° C. and the vessel walls may be heated to prevent condensation of water vapor, or excess water vapor may be fed to the vessel to maintain sufficient water vapor in the gas state. When the product being produced is ethanol, for example, it may be desirable to maintain the temperature of the vessel at about 75° C., or near the boiling point of ethanol of about 78° C.

The reactor vessel may include magnets mounted within the vessel to attract the negatively charged gas ions and create a zone that is more densely packed with gas ions. This can increase the probability of collisions between the gas ions and other gas molecules to cause reactions to occur. By producing electronegative gas ions with high energy and a strong reduction ability, the gas ions can react with carbon dioxide, which can be reduced to the desired organic products, such as ethanol.

Although the invention is not limited to any particular reaction mechanism, the inventors believe that the reaction of the electronegative gas ions with carbon dioxide is driven by the energy of the electron attached to the gas ion in the corona. As long as the total energy of the gas ions obtained from negative corona electron attachment is larger than the Gibbs free energy differences for the given gas reactions, the reactions are driven forward to the desired organic products. For example, in the production of ethanol by the reaction (4) shown below, three molecules of water vapor ions are needed. Each water vapor ion has approximately 5 eV or 482.5 kJ/mol of energy from the attached electron to drive the reaction forward. In the reaction to form ethanol, the three electronegative molecules of water vapor ions can provide a total of 1447.35 kJ of energy, which is greater than the Gibbs free energy of 1306.1 kJ required for the reaction.

The following description sets forth the various ions formed by electrons at the corona discharge, and the reactions that may occur between gas ions and neutral gas molecules in the reactor vessel. Carbon dioxide may undergo two types of interactions with the electrons in the corona discharge:

CO₂+e⁻→CO+1/20₂+e⁻ (1)

CO₂+e→CO₂⁻ (₂)

The CO2⁻ anions can react with neutral gas molecules as described below to form organic compounds.

Although water vapor molecules do not have an electron affinity due to their closed electron shells, water vapor molecules can have strong attractive polarization interactions with the excess electrons in the corona discharge, thereby binding an excess electron and releasing energy. It is expected that under the negative corona discharge, water vapor can obtain an excess electron to form H2O⁻.

The process of the invention has been used to produce ethanol using water vapor and CO₂ gas at ambient pressure and temperatures of 50-150° C. Ethanol is formed a small amount of methanol and oxalic acid as side products. Carbon dioxide ions may be formed as described above. Water vapor ions are formed at the corona discharge as follows:

H₂O+e⁻→H₂O⁻ (3)

The water vapor ions and carbon dioxide ions may react with neutral gas molecules in the reactor vessel to form ethanol. It is believed that the conversion of CO₂ to ethanol takes place through the following reactions:

3H₂O⁻+2CO→C₂H₅OH+2O₂+3e⁻ (4)

3H₂O⁻+2CO→C₂H₅OH+3O₂+3e⁻ (5)

3H₂O+2CO₂⁻→C₂H₅OH+3O₂+e⁻ (6)

Methanol may be formed in the reactor vessel by the following reactions:

4H₂O⁻+2CO₂→2CH₃OH+30₂+4e⁻ (7)

2H₂O⁻+CO→CH₃OH+O₂+2e⁻ (8)

Oxalic acid may be formed in the reactor vessel by the following reaction:

$$6 {H}_{2} {O}^{-} + 2 {CO}_{2} \to 2 {C}_{2} {H}_{2} {O}_{4} + \frac{1}{2} {O}_{2} + 6 {e}^{-} \qquad ( 9 )$$

Ammonia is an electronegative gas that can accept an attached electron in the corona discharge by the following reactions:

NH₃+e⁻→NH₃⁻ (10)

NH₃+e⁻→NH₂⁻+H (11)

The ammonia ions may react with carbon dioxide or carbon monoxide in the reactor vessel to form urea by the following reactions:

$$\begin{matrix}2 {NH}_{3}^{-} + {CO}_{2} \to {NH}_{2} {COONH}_{4} + 2 {e}^{-} & ( 12 ) \\ 2 {NH}_{3}^{-} + {CO}_{2}^{-} \to {NH}_{2} {COONH}_{4} + 2 {e}^{-} & ( 13 ) \\ 2 {NH}_{2}^{-} + CO \to {CO ( {NH}_{2} )}_{2} + {H}_{2} + 2 {e}^{-} & ( 14 ) \\ 2 {NH}_{2}^{-} + {CO}_{2} \to {CO ( {NH}_{2} )}_{2} + \frac{1}{2} {O}_{2} + 2 {e}^{-} & ( 15 ) \\ 2 {NH}_{2}^{-} + CO \to {CO ( {NH}_{2} )}_{2} + 2 {e}^{-} & ( 16 )\end{matrix}$$

Iodine is also an electronegative gas that can form negative ions in the corona discharge. At 70° C., tetraiodomethane can be successfully synthesized in carbon dioxide at a conversion rate of up to 88%. It is believed that this conversion takes place by the following steps:

2I₂⁻+CO₂→CI₄+O₂+2e⁻ (17)

2I₂+CO₂⁻→CI₄+O₂+e⁻ (18)

2I₂⁻+CO→CI₄+½O₂+e⁻ (19)

Other electronegative gases, such as for example chlorine or bromine, may be used in the methods of the present invention depending upon the reaction products that are desired.

Other sources of electrons having sufficient energy to convert CO2 to organic products may be used in the methods of the present invention. Electronegative ions of gases may be produced by other non-thermal or thermal plasma technologies or by using sources of negative ions, including high frequency methods, e.g., radio frequency plasma (RF), microwave plasma, inductively coupled plasma (ICP); and high voltage methods, e.g., dielectric barrier discharge (DBD), and electron beam (EB). Any method of generating electronegative gas ions having sufficient energy to react with CO₂ may be used in the methods of the invention.

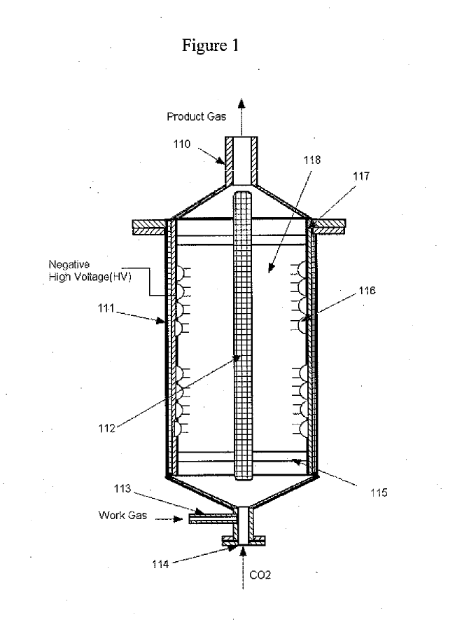

One embodiment of a reactor vessel for use in synthesizing ethanol or other organic molecules is illustrated in FIG. 1. The reactor vessel 100 comprises an outer shell 111. The outer shell may be steel, stainless steel or any other suitable material. Because the reaction is carried out at or very near atmospheric pressure, the outer shell thickness can be as low as ¼ inch.

A liner 117 may be included within the outer shell to reduce the likelihood of electric shock at the reactor outer shell. The liner 117 may be nickel or other suitable material. If desired, there may be an insulating material between the outer and inner shells. Alternatively, means may be provided to heat the inner shell to reduce condensation of water vapor or reaction products. The heating means may be, for example, electrical heating elements on a steam jacket.

A plurality of electrodes 116 are attached to the inner wall of the reactor vessel. The electrodes may be in the shape of a needle or wire with a sharp point. The electrodes may be made from nickel, copper, silver, iron, steel, tungsten, carbon or platinum, or any other appropriate material that may be used for an electrode to generate a negative corona in the vicinity of the electrode to produce electrons having an energy of about 4-5 eV. The electrodes may be coated with a metal catalyst. Examples of precious metal catalysts that may be used include nickel, rhodium, cobalt, phosphorous, cesium and platinum. Any precious metal catalyst capable of generating electrons having energy in the range of about 4-5 eV. may be used.

A negative high voltage supply (not shown) is connected to the plurality of electrodes 116. In one embodiment, the high negative voltage supply provides a voltage of at least −1 kV. The voltage is selected such that the electronegative gas supplied to the reactor vessel is highly ionized within the reaction chamber 118.

In operation, when the electrodes 116 are energized by the negative high voltage source, a negative corona forms at the electrode tips to form a negative corona field. An electronegative gas, such as water vapor, is fed to the reactor vessel through inlet 113. The water vapor enters the reaction chamber and is exposed to the negative corona field generated at the electrode tips. Energized electrons in the corona are attached to the water molecules to generate electronegative water ions.

Carbon dioxide is fed to the reactor vessel through inlet 113. Some of the carbon dioxide molecules may receive an energized electron in the corona field to form electronegative carbon dioxide molecules. The energized water vapor/carbon dioxide ions react with neutral water vapor/carbon dioxide molecules to form ethanol. When the vessel is maintained at a temperature above about 78° C., ethanol vapor, together with reaction by-products, some water vapor and CO₂, is collected through outlet 110. Where the product is produced in a liquid form, an outler pipe may be provided at the bottom of the reactor vessel to collect the reaction product.

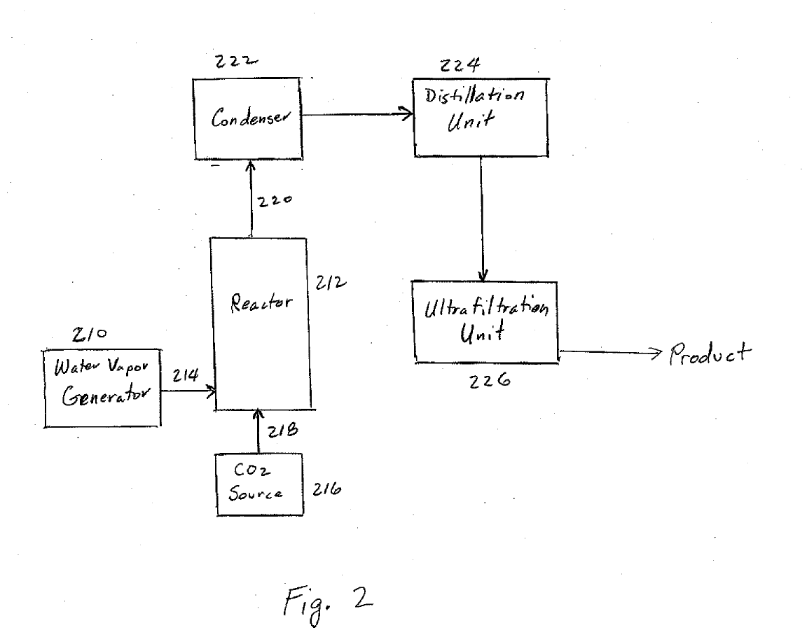

In one embodiment, a column 112 is provided within the reactor vessel containing magnetic bars or beads. The column may be comprised of a metal net, such as for example a nickel mesh, nickel sponge, platinum screen or graphene, to contain the magnetic bars or beads inside. The magnetic bars or beads induce a magnetic field around the column 112 to attract the electronegative water vapor ions and carbon dioxide ions and thereby create a volume that is dense in ions. The column 112 may be supported within the vessel by supporting tube 115. A flow diagram for an exemplary ethanol production facility is shown in FIG. 2. A water vapor generator 210 feeds water vapor to reactor vessel 212 through first inlet 214. A source of carbon dioxide 216 is provided to feed carbon dioxide to reactor vessel 212 through second inlet 218. Controlled conversion devices may be used for the use of liquid or solid CO2 as a gas source.

The water vapor is ionized in the reactor vessel and reacts with the CO₂ to form ethanol as described above. The ethanol product exits the reactor vessel with water vapor and by-products such as methanol and oxalic acid through outlet 220. The product stream is fed to a condenser 222 where it is condensed to a liquid. The outlet from condenser 222 is fed to a distillation unit 224 to separate and purify the ethanol. The product stream from the distillation unit may contain up to 95% ethanol.

If desired, the product stream from the distillation unit may be fed to an ultrafiltration unit 226 to produce the final ethanol product.

As will be recognized by those of ordinary skill in the pertinent art based on the teachings herein, numerous changes and modifications may be made to the above-described and other embodiments of the invention without departing from its scope as defined in the appended claims. Accordingly, this detailed description of preferred embodiments is to be taken in an illustrative as opposed to a limiting sense.

### REFERENCES

All publications and patents mentioned herein, including those items listed below, are hereby incorporated by reference in their entirety as if each individual publication or patent was specifically and individually incorporated by reference. In case of conflict, the present application, including any definitions herein, will control.

[1] O'Neill B C., Dalton M., Fuchs R., et al. (2010) Proceedings of the National Academy of Sciences[C]. 107(41):17521-17526

[2] Halmann M. M., Steinberg M. (1999) Greenhouse Gas Carbon Dioxide Mitigation[J].CRC, Press: Boca Raton.

[3] Barzagli F., Mani F., Peruzzini M., (2011)From greenhouse gas to feedstock: formation of ammonium carbamate from CO2 and NH3 in organic solvents and its catalytic conversion into urea under mild conditions[J]. Green Chem., 13 (5): 1267-1274.

[4] Pietruszka B., Heintze M., (2004) Methaneconversion at low temperature: the combined application of catalysis and non-equilibrium plasma[J]. Catalysis Today, 90(1-2):151-158. Spencer L. F., Gallimore A. D., (2010) Efficiency of CO2 Dissociation in a Radio-Frequency Discharge[J]. Plasma Chem. Plasma Process, 31(1):79-89

[5] Liu C. J., Mallinson R., Lobban L., (1999) Comparative investigations on plasma catalytic methane conversion to higher hydrocarbons over zeolites[J]. Applied Catalysis A: General. 178(1):17-27.

[6] Christophorou L. G., (1984) Electron-Molecule Interactions and their Applications[J]. New York: Academic

[7] Stoffels, E, Stoffels, W W and Kroesen, G M W, et al. (2001) Plasma chemistry and surface processes of negative ions [J]. Plasma Sources Sci. Technol. 11(4):311-317.

[8] Zhukhovitskii D. I., Schmidt W. F, Illenberger E., (2003) Stability of negative ions near the surface of a solid[J]. Journal of Experimental and Theoretical Physics, 97(3):606-614

[9] Chen J., Davidson J. H., (2003) Model of the Negative DC Corona Plasma: Comparison to the Positive DC Corona Plasma[J]. Plasma Chemistry and Plasma Processing, 23(1):83-102.

[10] Rienstra-Kiracofe J. C., Tschumper G. S., Schaefer III H. F., et al. (2002) Atomic and molecular electron affinities: photoelectron experiments and theoretical computations[J], Chem. Rev. 102:231-282.

[11] Gutsev G. L., Bartlett R. J., Compton R. N. (1998) Electron affinities of CO2, OCS, and CS2[J].Chem. Phys., 108:6756-6763.

We claim:

1. A method of converting carbon dioxide to organic compounds comprising the steps of:
mixing at least one electronegative gas with carbon dioxide in a vessel having at least one electrode;
applying a negative voltage to the at least one electrode to generate a negative corona discharge at the tip of the electrode to produce electronegative ions at an energy sufficient to convert the carbon dioxide to an organic compound.

2. The method according to claim 1, wherein the electronegative gas is selected from the group consisting of water vapor, ammonia, iodine, bromine, chlorine and combinations thereof.

3. The method according to claim 1, wherein the electronegative gas is water vapor and the organic compound is ethanol.

4. The method according to claim 1, wherein the electronegative gas is ammonia and the organic compound is urea.

5. The method according to claim 1, wherein the electronegative gas is iodine and the organic compound is tetraiodomethane.

6. An apparatus for converting carbon dioxide to organic compounds comprising:
an outer shell defining a reactor volume within the outer shell;
at least one electrode fixedly attached to the outer shell with the tip of the electrode extending into the reactor volume;
at least one supply line to provide feed gases to the reactor volume; and
an outlet line to remove reaction products from the reactor volume.

7. The apparatus of claim 6, further comprising a plurality of electrodes fixedly attached to the outer shell and extending into the reactor volume.

8. The apparatus of claim 7, wherein the electrodes are in the shape of a needle or wire.

9. The apparatus of claim 8, wherein the electrodes are comprised of a metal selected from the group consisting of nickel, copper, silver, iron, steel, tungsten or platinum.

10. The apparatus of claim 8, wherein the electrodes are comprised of carbon.

11. The apparatus of claim 9, wherein the electrode is coated with a reaction specific catalytic material.

12. The apparatus of claim 11, wherein the electrodes are coated with a catalyst selected from the group consisting of nickel, rhodium, cobalt, phosphorous, cesium and platinum.

13. The apparatus of claim 9, further comprising means for inducing a magnetic field within the reactor volume.

14. The apparatus of claim 9, further comprising a metal column fixed within the reactor volume, wherein the metal column contains a plurality of magnetic bars or beads.

15. The apparatus of claim 14, wherein the metal column is a metal mesh.

16. The apparatus of claim 15, wherein the metal mesh is selected from the group consisting of nickel mesh, catalyst-coated copper mesh, nickel sponge wrapped nickel mesh, and graphene wrapped nickel mesh.

17. A method of converting carbon dioxide to organic compounds comprising the steps of:
mixing at least one electronegative gas with carbon dioxide in a vessel having at least one source of electrons to form negative ions; and
generating an electron discharge within the vessel from the source of electrons to generate electronegative ions at an energy sufficient to convert the carbon dioxide to an organic compound.

18. The method of claim 17, wherein the source of electrons is selected from the group consisting of radio frequency plasma (RF), microwave plasma, inductively coupled plasma (ICP), dielectric barrier discharge (DBD), and electron beam (EB).
